(19) United States
(12) Patent Application Publication
(10) Pub. No.: US 2026/0200542 A1
(43) Pub. Date: Jul. 16, 2026

(54) ADJUSTABLE SUPPORT WHEEL ASSEMBLY AND TRACK SYSTEM WITH SAME FOR A VEHICLE

(71) Applicant: SOUCY INTERNATIONAL INC., Drummondville (CA)

(72) Inventors: Jeremie AUBIN-MARCHAND, Saint-Hugues (CA); Alexandre GAUTHIER, Drummondville (CA)

(21) Appl. No.: 19/448,812

(22) Filed: Jan. 14, 2026

Related U.S. Application Data
(60) Provisional application No. 63/745,523, filed on Jan. 15, 2025.

(51) Int. Cl. B62D 55/15; B62D 55/10

(52) U.S. Cl. CPC B62D 55/15; B62D 55/10

(57) ABSTRACT

Vehicles, track systems, and adjustable support wheel assemblies are disclosed. The adjustable support wheel has a subframe, one or more support wheels rotationally connectable to the subframe, and a shaft for pivotably connecting the subframe relative to a frame of the track system. At least one of the subframe, the one or more support wheels, and the shaft are selectively and removably connectable in at least two configurations relative to the frame for selectively adjusting a ground contact area of an endless track of the track system and/or selectively adjusting a pressure applied by the track system on the endless track.

### CROSS-REFERENCE TO RELATED APPLICATION

This application claims the benefit of and priority to U.S. provisional patent application No. 63/745,523, filed on Jan. 15, 2025; the content of all of which is herein incorporated in entirety by reference.

### TECHNICAL FIELD

The present technology relates to adjustable support wheel assemblies and track systems and vehicles comprising such adjustable support wheel assemblies.

### BACKGROUND

Certain types of vehicles, such as agricultural vehicles (e.g., harvesters, combines, tractors), construction vehicles (e.g., bulldozers, front-end loaders), and off-road vehicles, including all-terrain vehicles (ATVs) and utility task vehicles (UTVs), are frequently operated on ground surfaces that are soft, slippery, or uneven. These surfaces may include soil, mud, sand, ice, and snow, presenting unique challenges to vehicle mobility and stability.

Traditionally, these vehicles have utilized large wheels equipped with tires to traverse various ground surfaces. However, under specific conditions, such tires may struggle to gain sufficient traction on certain terrains, such as mud or ice. Additionally, due to the generally heavy weight of these vehicles, the tires often exert significant pressure on the ground surface, which can cause undesirable compaction, particularly in agricultural settings where soil health is a concern.

To address these challenges, track systems were developed as an alternative to traditional wheels and tires on certain vehicles. Track systems can improve traction and distribute the vehicle's weight more evenly over a larger surface area, reducing the likelihood of ground compaction. For instance, agricultural vehicles equipped with track systems are capable of operating in wet field conditions, where wheeled vehicles might otherwise become immobilized.

While beneficial in some respects, conventional track systems present their own set of challenges. Endless tracks in these track systems often experience uneven load distribution, leading to excessive stress and increased heat generation within the tracks. These factors contribute to accelerated wear and premature failure of the endless tracks.

Therefore, there is a need for enhanced endless tracks and track systems designed to address these issues by optimizing ground contact area and managing pressure applied across the endless track under various seasonal conditions.

### SUMMARY

It is an object of the present technology to ameliorate at least some of the inconveniences present in the prior art.

In the context of the following description, “laterally outwardly” or “laterally outward” means away from a longitudinal center plane of the track system, and “laterally inwardly” or “laterally inward” means toward the longitudinal center plane. In addition, in the context of the following description, “longitudinally” means in a direction parallel to the longitudinal center plane of the track system in a plane parallel to flat level ground, “laterally” means in a direction perpendicular to the longitudinal center plane in a plane parallel to flat level ground, and “generally vertically” means in a direction contained in the longitudinal center plane, or parallel to the longitudinal center plane, along a height direction of the track system generally perpendicular to flat level ground. In the following description and accompanying Figures, the track system is configured to be attached to a right side of the chassis of the vehicle.

In the context of the present specification, unless expressly provided otherwise, the words “first”, “second”, “third”, etc. have been used as adjectives only for the purpose of allowing for distinction between the nouns that they modify from one another, and not for the purpose of describing any particular relationship between those nouns.

It must be noted that, as used in this specification and the appended claims, the singular form “a”, “an” and “the” include plural referents unless the context clearly dictates otherwise.

As used herein, the term “about” in the context of a given value or range refers to a value or range that is within 20%, preferably within 10%, and more preferably within 5% of the given value or range.

As used herein, the term “and/or” is to be taken as specific disclosure of each of the two specified features or components with or without the other. For example, “A and/or B” is to be taken as specific disclosure of each of (i) A, (ii) B and (iii) A and B, just as if each is set out individually herein.

Implementations of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects, and advantages of implementations of the present technology will become apparent from the following description, the accompanying drawings, and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a right side elevation view of a harvester having a track system with an endless track;

FIGS. 2A-2B is a schematic illustration of a first embodiment of the track system of FIG. 1;

FIGS. 3A-3C is a schematic illustration of a second embodiment of the track system of FIG. 1;

FIGS. 4A-4D is a schematic illustration of a third embodiment of the track system of FIG. 1;

FIGS. 5A-5D is a schematic illustration of a fourth embodiment of the track system of FIG. 1;

FIGS. 6A-2D is a schematic illustration of a fifth embodiment of the track system of FIG. 1;

FIGS. 7A-7D is a schematic illustration of a sixth embodiment of the track system of FIG. 1;

FIGS. 8A-8B is a schematic illustration of a seventh embodiment of the track system of FIG. 1.

### DETAILED DESCRIPTION

The present disclosure is not limited in its application to the details of construction and the arrangement of components set forth in the following description or illustrated in the drawings. The disclosure is capable of other embodiments and of being practiced or of being carried out in various ways. Also, the phraseology and terminology used herein is for the purpose of description and should not be regarded as limiting. The use of “including”, “comprising”, or “having”, “containing”, “involving” and variations thereof herein, is meant to encompass the items listed thereafter as well as, optionally, additional items. In the following description, the same numerical references refer to similar elements.

The present technology relates to various embodiments of an endless track and will be described with reference to a track system.

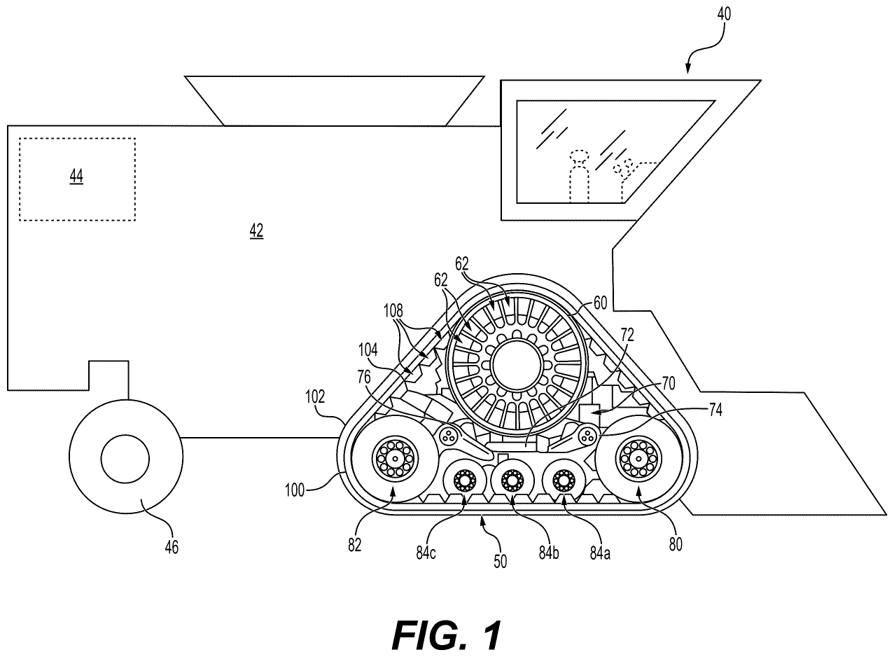

Referring to FIG. 1, a harvester 40 is shown. The harvester 40 has a frame 42 that houses an engine 44 (shown schematically). The harvester 40 also has left and right rear wheels 46 and left and right track systems 50 (only right rear wheel 46 and right track system 50 are shown in the accompanying FIGS). It is contemplated that in some embodiments, the harvester 40 could have more than two track systems. The engine 44 is operatively connected to left and right track systems 50. It is contemplated that in some embodiments, the engine 44 could be operatively connected to the rear wheels 46. It is understood that the present technology could be used with other agricultural vehicles. Additionally, the present technology could also be used with other vehicles such as all-terrain-vehicles, snowmobiles, side-by-side vehicles or utility-terrain vehicles. It is further contemplated that the present technology could be used with industrial vehicles, exploratory vehicles and/or military vehicles. It is also contemplated that the present technology could be used with trailers or other unpowered vehicles.

Still referring to FIG. 1, the track system 50 has a driving wheel assembly 60 that is operatively connected to an axle (not shown) of the harvester 40, such that when the axle rotates, the driving wheel assembly 60 also rotates, thereby driving the track system 50. It is contemplated that in some embodiments, the driving wheel assembly 60 could be configured to connect to a non-driving axle of a vehicle. The driving wheel assembly 60 defines a plurality of recesses 62. The plurality of recesses 62 are defined circumferentially on a periphery of the driving wheel assembly 60. The recesses 62 are configured, as will be described in greater detail below, to engage with lugs 108 provided on an inner surface 104 of the endless track 100. Other driving configurations are contemplated as well.

The track system 50 also has a frame 70 that is rotationally connected to the driving wheel assembly 60 and that is disposed laterally inwardly therefrom. It is contemplated that in other embodiments, the frame 70 could be disposed laterally outwardly from the driving wheel assembly 60. The frame 70 has a main frame member 72, a leading frame member 74 and a trailing frame member 76 where the leading and trailing frame members 74, 76 are pivotally connected to the main frame member 72.

The track system 50 includes wheel assemblies. More precisely, the track system 50 includes the driving wheel assembly 60, a front idler wheel assembly 80, a rear idler wheel assembly 82 and three support wheel assemblies 84a, 84b, 84c which are disposed longitudinally between the front and rear idler wheel assemblies 80, 82. It is contemplated that in some embodiments, the track system 50 could have more or less than three support wheel assemblies.

The front idler wheel assembly 80 and the support wheel assembly 84a are rotationally connected to the leading frame member 74. The support wheel assemblies 84b, 84c are connected to form a tandem which in turn is pivotally connected to the trailing frame member 76. The rear idler wheel assembly 82 is also connected to the trailing frame member 76. Thus, the track system 50 can, to some extent, conform to encounter obstacles. Other configurations are contemplated as well.

Each one of the front and rear idler wheel assemblies 80, 82, and/or of the support wheel assemblies 84a, 84b, 84c has two laterally spaced wheels, such that each one of the front and rear idler wheel assemblies 80, 82, and the support wheel assemblies 84a, 84b, 84c has left and right wheels (only the right wheel of each of the wheel assemblies 80, 82, 84 is shown in FIG. 1). It is contemplated that in some embodiments, one or more of the front and rear idler wheel assemblies 80, 82, and the support wheel assemblies 84a, 84b, 84c could be configured to have a single wheel or three or more wheels.

It is contemplated that in some embodiments, the track system 50 could include a tensioner (not shown) that is configured to adjust and/or maintain tension in the endless track 100, as known in the art.

The endless track 100 extends around components of the track system 50, such that the endless track 100 surrounds the driving wheel assembly 60, the frame 70, the front and rear idler wheel assemblies 80, 82, and the support wheel assemblies 84a, 84b, 84c.

The endless track 100 comprises a carcass 102 that, as will be described in further detail below, forms a construction of different components and/or materials. In some embodiments, the carcass 102 may include a body made of an elastomeric material, such as polymer, e.g. rubber in which reinforcement layers are embedded.

The carcass 102 can be said to have a width and a length. The carcass 102 can be said to have an inner surface that is configured to be engaged by the driving wheel assembly 60, the front and rear idler wheel assemblies 80, 82 and the support wheel assemblies 84a, 84b, 84c. The carcass 102 can be said to have an outer surface that is configured to engage a ground surface.

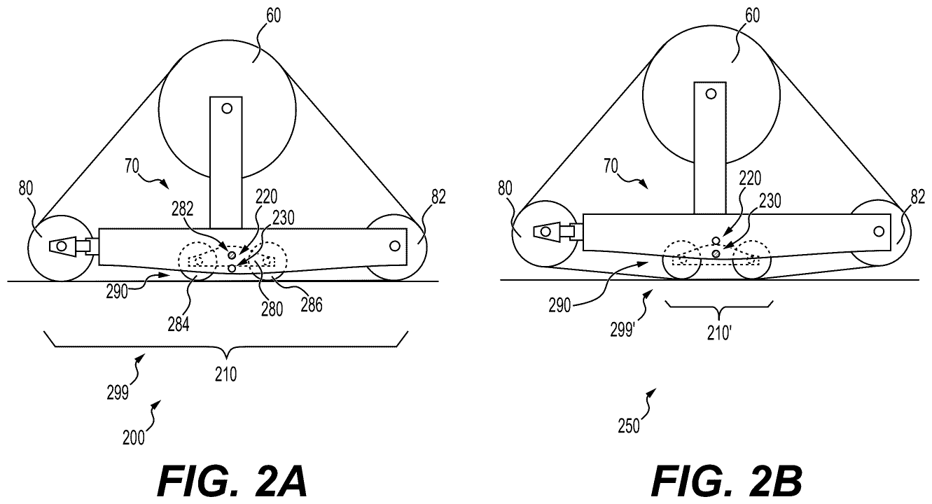

In at least some embodiments of the present technology, the track system 50 may comprise at least one adjustable support wheel assembly, in addition to, or instead of, the one or more of the support wheel assemblies 84a, 84b, 84c illustrated in FIG. 1. Different embodiments of the track system 50 comprising at least one adjustable support wheel assembly will now be described with reference to FIGS. 2A-8B. It should be noted that one or more components of the track system 50 may be omitted from the schematic illustrations in FIGS. 2A-8B for clarity purposes only.

### First Embodiment

With reference to FIGS. 2A and 2B, there is depicted a schematic illustration of a first embodiment of the track system 50 in a first configuration 200 (FIG. 2A) and a second configuration 250 (FIG. 2B). The track system 50 comprises the drive wheel assembly 60, the frame 70, the front and rear idler wheel assemblies 80 and 82, and the endless track 100. In FIG. 2A, the track system 50 comprises an adjustable wheel assembly 290 connected to the frame 70 in a first configuration 299. In FIG. 2B, the track system 50 comprises the adjustable wheel assembly 290 connected to the frame 70 in a second configuration 299′. It is contemplated that the adjustable wheel assembly 290 may be connected to the frame 70 in more than two configurations, without departing from the scope of the present technology.

In this embodiment, the adjustable wheel assembly 290 comprises a subframe 280, a shaft 282 for pivotably connecting the subframe 280 relative to the frame 70, and support wheels 284 and 286 rotationally connected to the subframe 280.

In the first configuration 299, the shaft 282 is connected to the frame 70 via first interface 220. When the adjustable support assembly 290 is connected in the first configuration 299 to the frame 70 via the interface 220, the endless track 100 has a first ground contact area 210. In the second configuration 299′, the shaft 282 is connected to the frame 70 via a second interface 230. The second interface 230 is vertically offset from the first interface 220 on the frame 70. When the adjustable support assembly 290 is connected the second configuration 299′ to the frame 70, the endless track 100 has a second ground contact area 210′. The first ground contact area 210 is larger than the second ground contact area 210′.

When the adjustable support assembly 290 is connected in the first configuration 299 to the frame 70, the first ground contact area 210 spans longitudinally from the idler wheel assembly 80 to the idler wheel assembly 82. When the adjustable support assembly 290 is connected in the second configuration 299′ to the frame 70, the second ground contact area 210′ is longitudinally shorter than the first ground contact area 210. In some instances, the second ground contact area 210′ spans longitudinally from support wheel 284 to support wheel 286.

When the adjustable support assembly 290 is connected in the first configuration 299 to the frame 70, the subframe 280 is connected to the frame 70 at a first position relative to the frame 70. When the adjustable support assembly 290 is connected in the second configuration 299′ to the frame 70, the subframe 280 is connected to the frame 70 in a second position relative to the frame 70. The first position is different from the second position.

It is contemplated that the first interface 220 and the second interface 230 may be embodied as apertures defined in the frame 70 for selectively receiving the shaft 282. Other interfaces are also contemplated for selectively connecting the adjustable support assembly 290 in the first position relative to the frame 70 (i.e., see FIG. 2A where the shaft 282 is selectively connected via the first interface 220 to the frame 70) and in the second position relative to the frame 70 (i.e., see FIG. 2B where the shaft 282 is selectively connected via the second interface 230 to the frame 70).

### Second Embodiment

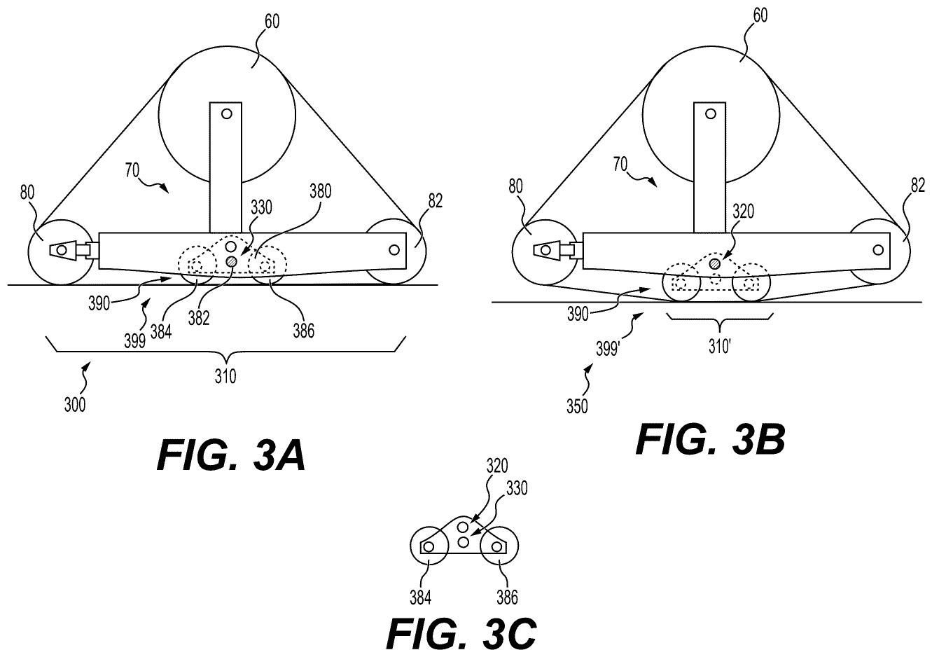

With reference to FIGS. 3A to 3C, there is depicted a schematic illustration of a second embodiment of the track system 50 in a first configuration 300 and a second configuration 350, respectively. The track system 50 comprises the drive wheel assembly 60, the frame 70, the front and rear idler wheel assemblies 80 and 82, and the endless track 100. In FIG. 3A, the track system 50 comprises an adjustable wheel assembly 390 connected to the frame 70 in a first configuration 399. In FIG. 2B, the track system 50 comprises the adjustable wheel assembly 390 connected to the frame 70 in a second configuration 399′. It is contemplated that the adjustable wheel assembly 390 may be connected to the frame 70 in more than two configurations, without departing from the scope of the present technology.

The adjustable wheel assembly 390 comprises a subframe 380, a shaft 382 for pivotably connecting the subframe 380 relative to the frame 70, and support wheels 384 and 386 rotationally connected to the subframe 380. It should be noted that, as opposed to the embodiment illustrated in FIGS. 2A and 2B, the shaft 382 may be a component of the frame 70 extending laterally away from the frame 70. It is contemplated that the shaft 382 may be a component of the adjustable wheel assembly 390 that is selectively connectable to the subframe 380 in different positions relative to the subframe 380.

In the first configuration 399, the shaft 382 connects to the subframe 380 via a first interface 330 of the subframe 380. When the adjustable support assembly 390 is connected in the first configuration 399 to the frame 70, the first ground contact area 310 spans longitudinally from the idler wheel assembly 80 to the idler wheel assembly 82. In the second configuration 399′, the shaft 382 connects to the subframe 380 via a second interface 320 of the subframe 380. When the adjustable support assembly 390 is connected in the second configuration 399′ to the frame 70, the second ground contact area 310′ is longitudinally shorter than the first ground contact area 310. In some instances, the second ground contact area 310′ spans longitudinally from support wheel 384 to support wheel 386.

When the adjustable support assembly 390 is connected in the first configuration 399 to the frame 70, the subframe 380 is connected to the frame 70 at a first position relative to the frame 70. When the adjustable support assembly 390 is connected in the second configuration 399′ to the frame 70, the subframe 380 is connected to the frame 70 in a second position relative to the frame 70. The first position is different from the second position. The first position of the subframe 380 is vertically offset from the second position of the subframe 380.

It is contemplated that the first interface 330 and the second interface 320 may be embodied as apertures defined in the subframe 380 for selectively receiving the shaft 382 extending from the frame 70. Other interfaces are also contemplated for selectively connecting the adjustable support assembly 390 in the first position (i.e., see FIG. 3A where the shaft 382 is selectively connected via the first interface 330 to the subframe 380) and in the second position (i.e., see FIG. 3B where the shaft 382 is selectively connected via the second interface 320 to the subframe 380).

It should be noted that in the embodiment illustrated in FIGS. 2A and 2B, the shaft 282 extends from the subframe 280 and is configured to be selectively received by the first interface 220 and the second interface 230 defined in the frame 70. In contrast, in the embodiment illustrated in FIGS. 3A to 3C, the shaft 382 is configured to be selectively received by the first interface 330 and the second interface 320 defined in the subframe 380.

### Third Embodiment

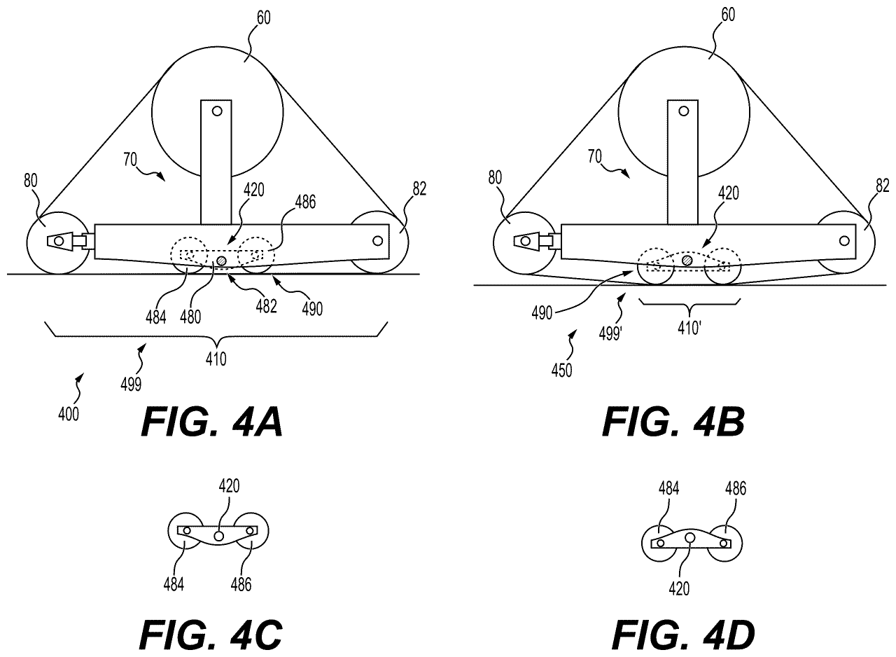

With reference to FIGS. 4A to 4D, there is depicted a schematic illustration of a third embodiment of the track system 50 in a first configuration 400 and a second configuration 450, respectively. The track system 50 comprises the drive wheel assembly 60, the frame 70, the front and rear idler wheel assemblies 80 and 82, and the endless track 100. In FIG. 4A, the track system 50 comprises an adjustable wheel assembly 490 connected to the frame 70 in a first configuration 499. In FIG. 4B, the track system 50 comprises the adjustable wheel assembly 490 connected to the frame 70 in a second configuration 499′. It is contemplated that the adjustable wheel assembly 490 may be connected to the frame 70 in more than two configurations, without departing from the scope of the present technology.

The adjustable wheel assembly 390 comprises a subframe 480, a shaft 482 for pivotably connecting the subframe 480 relative to the frame 70, and support wheels 484 and 486 rotationally connected to the subframe 480.

In the first configuration 499, the subframe 380 is connected to the frame 70 in a first orientation via an interface 420. When the adjustable support assembly 490 is connected in the first configuration 499 to the frame 70, the first ground contact area 410 spans longitudinally from the idler wheel assembly 80 to the idler wheel assembly 82. In the second configuration 499′, the subframe 380 is connected to the frame 70 in a second orientation via the interface 420. When the adjustable support assembly 490 is connected in the second configuration 499′ to the frame 70, the second ground contact area 410′ is longitudinally shorter than the first ground contact area 410. In some instances, the second ground contact area 410′ spans longitudinally from support wheel 484 to support wheel 486.

It should be noted that the subframe 480 has an asymmetrical shape. The asymmetrical shape of the subframe 480 allows for the support wheels 484 and 486 to be at different positions relative to the frame 70 depending on inter alia whether the subframe 480 is connected in a first or the second orientation relative to the frame 70. In other words, due to the asymmetrical shape of the subframe 480, (i) when the subframe 480 is connected to the frame 70 in the first orientation relative to the frame 70, the support wheels 484 and 486 are located at a first position relative to the frame 70, and (ii) when the subframe 480 is connected to the frame 70 in the second orientation relative to the frame 70, the support wheels 484 and 486 are located at a second position relative to the frame 70.

In further embodiments, it is contemplated that the subframe 480 may be selectively connectable in more than one orientation and/or in more than one position relative to the frame 70. For example, in addition to being selectively connectable in more than one orientation relative to the frame 70, the subframe 480 may be selectively connectable to the frame 70 in more than one positions via one or more interfaces (such as interface 220, 230, 320 and 330, for example).

### Fourth Embodiment

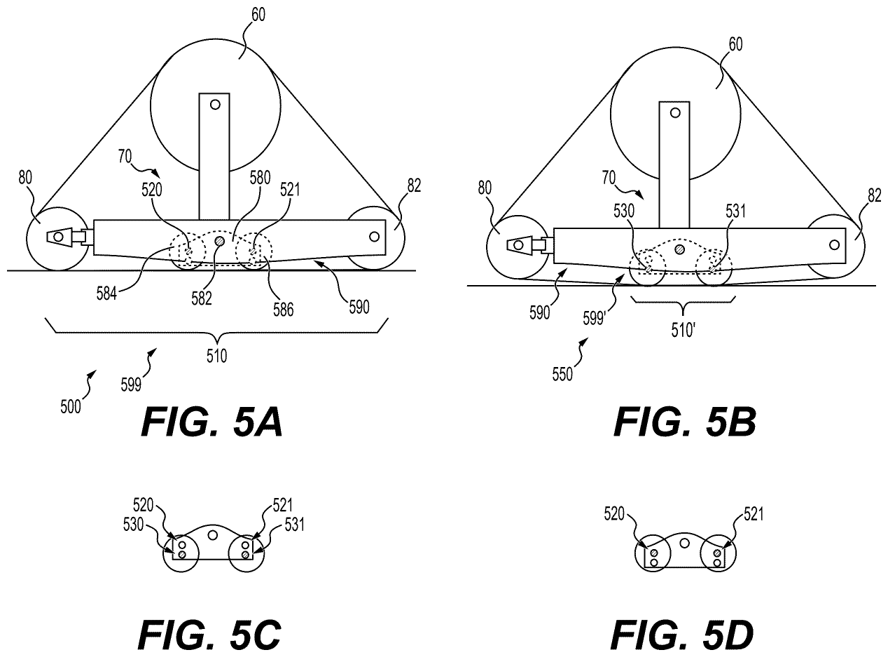

With reference to FIGS. 5A-5D, there is depicted a schematic illustration of a fourth embodiment of the track system 50 in a first configuration 500 and a second configuration 550, respectively. The track system 50 comprises the drive wheel assembly 60, the frame 70, the front and rear idler wheel assemblies 80 and 82, and the endless track 100. In FIG. 5A, the track system 50 comprises an adjustable wheel assembly 590 connected to the frame 70 in a first configuration 599. In FIG. 4B, the track system 50 comprises the adjustable wheel assembly 590 connected to the frame 70 in a second configuration 599′. It is contemplated that the adjustable wheel assembly 590 may be connected to the frame 70 in more than two configurations, without departing from the scope of the present technology.

The adjustable wheel assembly 590 comprises a subframe 580, a shaft 582 for pivotably connecting the subframe 580 relative to the frame 70, and support wheels 584 and 586 rotationally connected to the subframe 580.

In the first configuration 599, the support wheels 584 and 586 are selectively connected to the subframe 580 via interfaces 520 and 521, respectively, of the subframe 580 and the subframe 580 is connected to the frame 70 via an interface 520. When the adjustable support assembly 590 is connected in the first configuration 599 to the frame 70(the first ground contact area 510 spans longitudinally from the idler wheel assembly 80 to the idler wheel assembly 82. In the second configuration 599, the support wheels 584 and 586 are selectively connected to the subframe 580 via interfaces 530 and 531, respectively, of the subframe 580 and the subframe 580 is connected to the frame 70 via the interface 520. When the adjustable support assembly 590 is connected in the second configuration 599′ to the frame 70, the second ground contact area 510′ is longitudinally shorter than the first ground contact area 510. In some instances, the second ground contact area 510′ spans longitudinally from support wheel 584 to support wheel 586.

When the adjustable support assembly 590 is connected in the first configuration 599 to the frame 70, the support wheels 582, 584 are connected to the subframe 580 at first positions relative to the subframe 580. When the adjustable support assembly 590 is connected in the second configuration 599′ to the frame 70, the support wheels 582, 584 are connected to the subframe 580 in second positions relative to the subframe 580. The first positions are different from the second positions.

It is contemplated that the interfaces 520 and 521 as well as the interfaces 530 and 531 may be embodied as apertures defined in the subframe 580 for selectively connecting the support wheels 584 and 586 to the subframe 580. Other interfaces are also contemplated for selectively connecting the support wheels 584 and 586 in respective first positions (see FIG. 5C) and in the respective second positions (see FIG. 5D).

### Fifth Embodiment

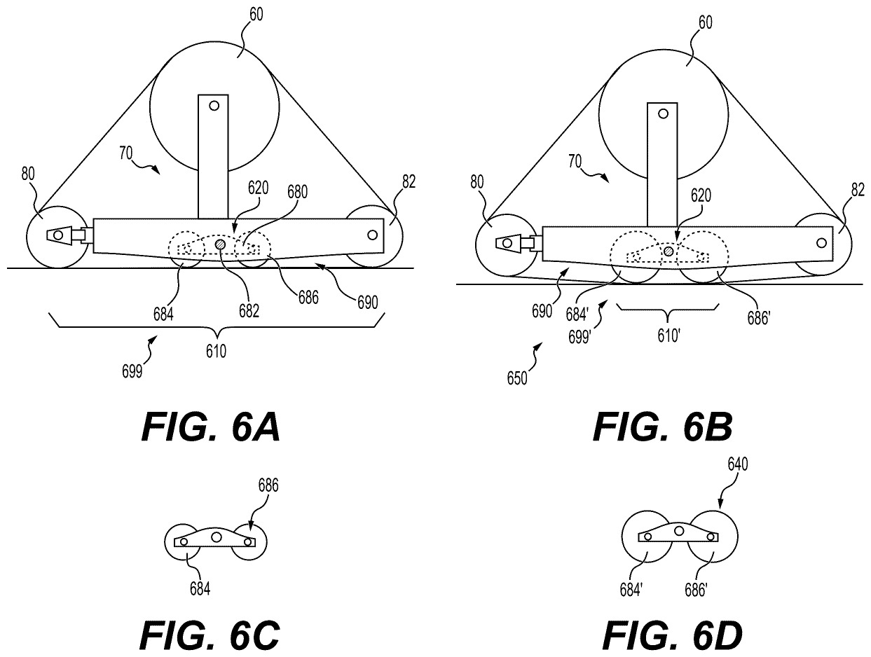

With reference to FIGS. 6A to 6D, there is depicted a schematic illustration of a fifth embodiment of the track system 50 in a first configuration 600 and a second configuration 650, respectively. The track system 50 comprises the drive wheel assembly 60, the frame 70, the front and rear idler wheel assemblies 80 and 82, and the endless track 100. In FIG. 6A, the track system 50 comprises an adjustable wheel assembly 690 connected to the frame 70 in a first configuration 699. In FIG. 6B, the track system 50 comprises the adjustable wheel assembly 690 connected to the frame 70 in a second configuration 699′. It is contemplated that the adjustable wheel assembly 690 may be connected to the frame 70 in more than two configurations, without departing from the scope of the present technology.

In the first configuration 699, the adjustable wheel assembly 690 comprises a subframe 680, a shaft 682 for pivotably connecting the subframe 680 relative to the frame 70, and support wheels 684 and 686 rotationally connected to the subframe 680. In the second configuration 699′, the adjustable wheel assembly 690 comprises the subframe 680, the shaft 682 for pivotably connecting the subframe relative to the frame 70, and support wheels 684′ and 6486′ rotationally connected to the subframe 680. In both the first and second configurations 699 and 699′, the subframe 680 is selectively connected to the frame 70 via an interface 620.

When the adjustable support assembly 690 is connected in the first configuration 699 to the frame 70, the first support wheels 684 and 686 are rotationally connected to the subframe 680. When the adjustable support assembly 690 is connected in the second configuration 699′ to the frame 70, the second support wheels 684′ and 686′ are rotationally connected to the subframe 680. The first support wheels 684 and 686 have a first size and the second support wheels 684′ and 686′ have a second size, The first size is different from the second size. In some instances, the first size is smaller than the second size. In some other instances, the first size is greater than the second size.

When the adjustable support assembly 690 is connected in the first configuration 699 to the frame 70, the first ground contact area 610 spans longitudinally from the idler wheel assembly 80 to the idler wheel assembly 82. When the adjustable support assembly 690 is connected in the second configuration 699′ to the frame 70, the second ground contact area 610′ is longitudinally shorter than the first ground contact area 610.

### Sixth Embodiment

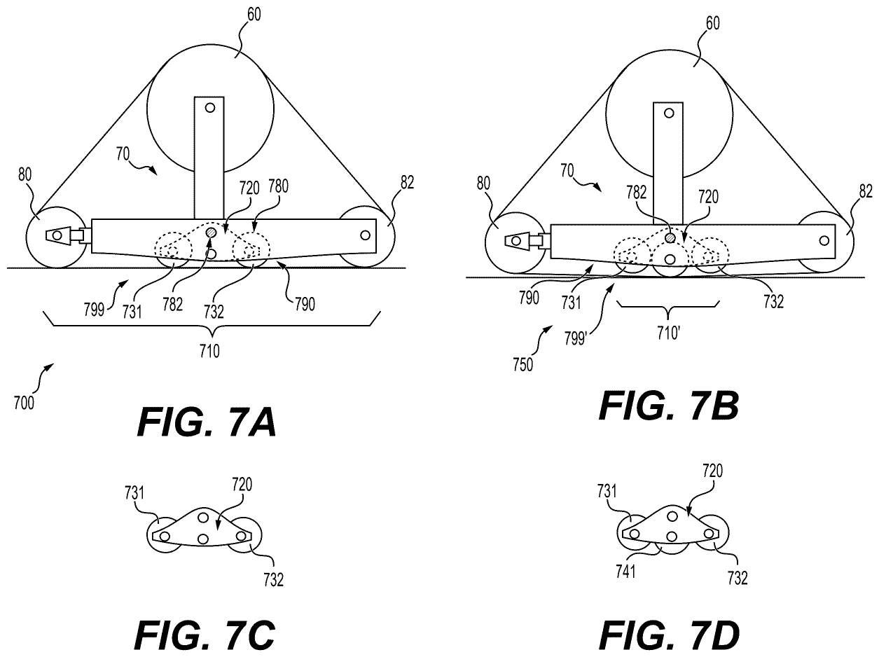

With reference to FIGS. 7A to 7D, there is depicted a schematic illustration of a sixth embodiment of the track system 50 in a first configuration 700 and a second configuration 750, respectively. The track system 50 comprises the drive wheel assembly 60, frame 70, the front and rear idler wheel assemblies 80 and 82, and the endless track 100. In FIG. 7A, the track system 50 comprises an adjustable wheel assembly 790 connected to the frame 70 in a first configuration 799. In FIG. 7B, the track system 50 comprises the adjustable wheel assembly 790 connected to the frame 70 in a second configuration 799′. It is contemplated that the adjustable wheel assembly 790 may be connected to the frame 70 in more than two configurations, without departing from the scope of the present technology.

In the first configuration 799, the adjustable wheel assembly 790 comprises a subframe 780, a shaft 782 for pivotably connecting the subframe 780 relative to the frame 70, and support wheels 731 and 732 rotationally connected to the subframe 780. In the second configuration 799′, the adjustable wheel assembly 790 comprises the subframe 780, the shaft 782 for pivotably connecting the subframe 780 relative to the frame 70, the support wheels 731 and 732, and a support wheel 741 rotationally connected to the subframe 780. In both the first and second configurations 799 and 799′, the subframe 780 is selectively connected to the frame 70 via an interface 720.

When the adjustable support assembly 790 is connected in the first configuration 799 to the frame 70, the first ground contact area 710 spans longitudinally from the idler wheel assembly 80 to the idler wheel assembly 82. When the adjustable support assembly 790 is connected in the second configuration 799′ to the frame 70, the second ground contact area 710′ is longitudinally shorter than the first ground contact area 710. In some instances, the second ground contact area 710′ spans longitudinally from support wheel 731 to support wheel 732.

When the adjustable support assembly 790 is connected in the first configuration 799 to the frame 70, only the first support wheels 730, 731 are rotationally connected to the subframe 780. When the adjustable support assembly 790 is connected in the second configuration 799′ to the frame 70, the first support wheels 730, 731 and the second support wheel 741 are rotationally connected to the subframe 780.

### Seventh Embodiment

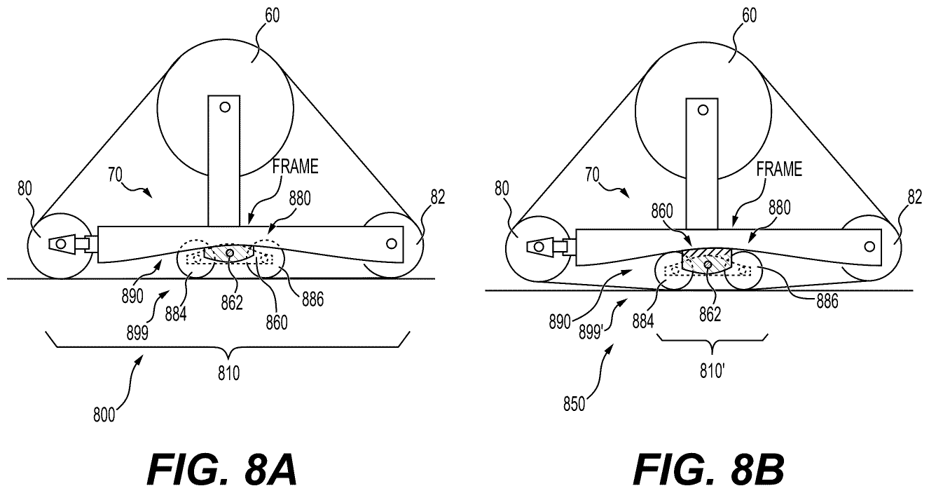

With reference to FIGS. 8A and 8B, there is depicted a schematic illustration of a seventh embodiment of the track system 50 in a first configuration 800 and a second configuration 850, respectively. The track system 50 comprises the drive wheel assembly 60, frame 70, the front and rear idler wheel assemblies 80 and 82, and the endless track 100. In FIG. 8A, the track system 50 comprises an adjustable wheel assembly 890 connected to the frame 70 in a first configuration 899. In FIG. 4B, the track system 50 comprises the adjustable wheel assembly 890 connected to the frame 70 in a second configuration 899′. It is contemplated that the adjustable wheel assembly 890 may be connected to the frame 70 in more than two configurations, without departing from the scope of the present technology.

In the first configuration 899, the adjustable wheel assembly 890 comprises a subframe 880, a shaft 862 for pivotably connecting the subframe 880 relative to the frame 70, and support wheels 884 and 886 rotationally connected to the subframe 880. In the second configuration 899′, the adjustable wheel assembly 890 comprises the subframe 880, a shim 860 for connecting the subframe 880 relative to the frame 70, the shaft 862 for pivotably connecting the subframe 880, and the support wheels 884 and 886. The shim 860 is configured to provide extra spacing between the subframe 880 and the frame 70.

When the adjustable support assembly 890 is connected in the first configuration 899 to the frame 70, the first ground contact area 810 spans longitudinally from the idler wheel assembly 80 to the idler wheel assembly 82. When the adjustable support assembly 890 is connected in the second configuration 899′ to the frame 70, the second ground contact area 810′ is longitudinally shorter than the first ground contact area 810. In some instances, the second ground contact area 810′ spans longitudinally from support wheel 884 to support wheel 886.

Any material(s) or method(s) of manufacture which produce such components may be used in the present technology.

Modifications and improvements to the above-described embodiments of the present technology may become apparent to those skilled in the art. The foregoing description is intended to be exemplary rather than limiting. The scope of the present technology is therefore intended to be limited solely by the scope of the appended claims.

1. A track system for a vehicle, the track system comprising:
a frame;
at least one adjustable support wheel assembly connectable to frame; and
an endless track for contacting a ground surface and surrounding the frame and the at least one adjustable support wheel assembly,
at least one component of the at least one adjustable support wheel assembly being selectively and removably connectable in at least two configurations relative to the frame for selectively adjusting a ground contact area of the endless track.

2. The track system of claim 1, wherein:
in a first one of the at least two configurations, the endless track has a first ground contact area, and
in a second one of the at least two configurations, the endless track has a second ground contact area,
the first ground contact area being different from the second ground contact area.

3. The track system of claim 1, further comprising a leading idler wheel rotationally connected to the frame, and a trailing idler wheel rotationally connected to the frame,
in the first one of the at least two configurations, the first ground contact area spans longitudinally from the leading idler wheel assembly to the trailing idler wheel assembly, and
in the second one of the at least two configurations, the second ground contact area is longitudinally shorter than the first ground contact area.

4. The track system of claim 3, wherein the first ground contact area spans from the leading idler wheel to the trailing idler wheel.

5. The track system of claim 3, wherein the at least one adjustable support wheel assembly comprises a first support wheel and a second support wheel, wherein the second ground contact area spans from the first support wheel to the second support wheel.

6. The track system of claim 1, wherein the at least one adjustable support wheel assembly comprises a subframe, at least one support wheel rotationally connectable to the subframe, and a shaft for pivotably connecting the subframe relative to the frame.

7. The track system of claim 6, wherein the at least one adjustable support wheel assembly further comprises a shim selectively and removably connectable to the subframe and the frame.

8. The track system of claim 6, wherein:
in the first one of the at least two configurations, the subframe is connected to the frame at a first position relative to the frame,
in the second one of the at least two configurations, the subframe is connected to the frame in a second position relative to the frame,
the first position being different from the second position.

9. The track system of claim 8, wherein the first position is vertically offset from the second position.

10. The track system of claim 6, wherein:
in the first one of the at least two configurations, the subframe is connected to the frame in a first orientation relative to the frame,
in the second one of the at least two configurations, the subframe is connected to the frame in a second orientation relative to the frame,
the first orientation being different from the second orientation.

11. The track system of claim 6, wherein:
in the first one of the at least two configurations, the at least one support wheel is connected to the subframe at a first position relative to the subframe,
in the second one of the at least two configurations, the at least one support wheel is connected to the subframe in a second position relative to the subframe,
the first position being different from the second position.

12. The track system of claim 6, wherein the at least one support wheel is a plurality of support wheels including at least one first support wheel and at least one second support wheel:
in the first one of the at least two configurations, the at least one first support wheel is rotationally connected to the subframe,
in the second one of the at least two configurations, the at least one second support wheel is rotationally connected to the subframe,
the at least one first support wheel having a first size and the at least one second support wheel having a second size, the first size being different from the first size.

13. The track system of claim 12, wherein:
in the first one of the at least two configurations, only the at least one first support wheel is rotationally connected to the subframe, and
in the second one of the at least two configurations, the least one first support wheel and the at least one second support wheel are rotationally connected to the subframe.

14. The track system of claim 6, wherein the subframe has an asymmetrical shape.

15. An adjustable support wheel assembly for a track system, comprising:
a subframe;
one or more support wheels rotationally connectable to the subframe;
a shaft for pivotably connecting the subframe relative to a frame of the track system,
wherein at least one of (i) the subframe, (ii) the one or more support wheels, and (iii) the shaft are selectively and removably connectable in at least two configurations relative to the frame for selectively adjusting a ground contact area of an endless track of the track system.

16. A track system for a vehicle, the track system comprising:
a frame;
at least one adjustable support wheel assembly connectable to frame; and
an endless track for contacting a ground surface and surrounding the frame and the at least one adjustable support wheel assembly,
at least one component of the at least one adjustable support wheel assembly being selectively and removably connectable in at least two configurations relative to the frame for selectively adjusting a pressure applied by the track system on the endless track.
